(19) United States
(12) Patent Application Publication
(10) Pub. No.: US 2026/0273942 A1
(43) Pub. Date: Sep. 17, 2026

(54) Cleaning Device

(71) Applicant: SEIKO EPSON CORPORATION, Tokyo (JP)

(72) Inventors: Eiji OSAWA, Matsumoto (JP); Tomohiro SAYAMA, Matsumoto (JP); Hisayuki KOIKE, Shiojiri (JP)

(21) Appl. No.: 19/567,869

(22) Filed: Mar. 16, 2026

(30) Foreign Application Priority Data
Mar. 17, 2025 (JP) 2025-042103

(51) Int. Cl. B41J 2/165

(52) U.S. Cl. CPC B41J 2/16517; B41J 2002/16567

(57) ABSTRACT

A cleaning device for cleaning a nozzle plate having an ejection surface and nozzles for ejecting a liquid formed therein, includes a cap disposed to face the ejection surface, having a recess, and can store the liquid in a space surrounded by the recess and the ejection surface, an ultrasonic device provided in the cap, transmitting ultrasonic waves toward the ejection surface, and having ultrasonic vibrators arranged in a first direction, and a controller inputting a burst signal to the ultrasonic device for control, wherein each of the ultrasonic vibrators transmits ultrasonic burst waves when the burst signal is input, and the controller acquires a deposition range in which deposits are deposited, sets a target range using the deposition range, and controls the ultrasonic device to focus the ultrasonic waves in the target range.

The present application is based on, and claims priority from JP Application Serial Number 2025-042103, filed Mar. 17, 2025, the disclosure of which is hereby incorporated by reference herein in its entirety.

### BACKGROUND

### 1. Technical Field

The present disclosure relates to a cleaning device.

### 2. Related Art

In the related art, there is a technique of removing deposits deposited on an ejection nozzle that ejects a liquid using ultrasonic waves (for example, JP-A-2006-347000). In the device of JP-A-2006-347000, an ultrasonic vibrator is provided in a cap that covers the ejection nozzle, and ultrasonic waves are transmitted from the ultrasonic vibrator with a space between the ejection nozzle and the ultrasonic vibrator filled with a liquid. As a result, the deposits are removed by the cavitation effect.

JP-A-2006-347000 is an example of the related art.

In the technique described above, the ultrasonic waves are propagated through the entire nozzle plate on which the ejection nozzle is formed, and the cleaning efficiency may be lower.

### SUMMARY

According to an aspect of the present disclosure, there is provided a cleaning device for cleaning a nozzle plate having an ejection surface and a plurality of nozzles for ejecting liquid formed therein. The cleaning device includes a cap that is disposed to face the ejection surface, has a recess, and is configured to store the liquid in a space surrounded by the recess and the ejection surface, an ultrasonic device that is provided in the cap and transmits ultrasonic waves toward the ejection surface, and has a plurality of ultrasonic vibrators arranged in a first direction, and a controller that inputs a burst signal to the ultrasonic device and controls the ultrasonic device, wherein each ultrasonic vibrator of the plurality of ultrasonic vibrators transmits ultrasonic burst waves when the burst signal is input, and the controller acquires a deposition range in which deposits are deposited of a range including the ejection surface and the plurality of nozzles, sets a target range using the deposition range, and controls the ultrasonic device to focus the ultrasonic waves in the target range.

### BRIEF DESCRIPTION OF THE DRAWINGS

FIG. 1 is a schematic view showing a schematic configuration of a liquid ejection apparatus.

FIG. 2 is an exploded perspective view of a liquid ejection head.

FIG. 3 is a schematic cross-sectional view of a part of the liquid ejection head and a cleaning device.

FIG. 4 shows an acoustic lens.

FIG. 5 is a plan view of an ultrasonic device.

FIG. 6 is a cross-sectional view taken along line VI-VI in FIG. 5.

FIG. 7 is a perspective view showing a relationship between channels and nozzles.

FIG. 8 is a waveform diagram of a burst signal.

FIG. 9 shows a relationship between the burst signals and ultrasonic waves.

FIG. 10 is a flowchart showing a procedure of cleaning processing.

FIG. 11 is a flowchart showing a procedure of cleaning processing of a second embodiment.

FIG. 12 shows a correspondence relationship between first and second candidate ranges and first and second groups.

FIG. 13 shows the first candidate range and the second candidate range of the second embodiment.

FIG. 14 shows a first candidate range and a second candidate range of a third embodiment.

FIG. 15 is a perspective view showing a relationship between channels and nozzles of a fourth embodiment.

### DESCRIPTION OF EMBODIMENTS

### A. First Embodiment

### A1. Overall Configuration of Liquid Ejection Apparatus

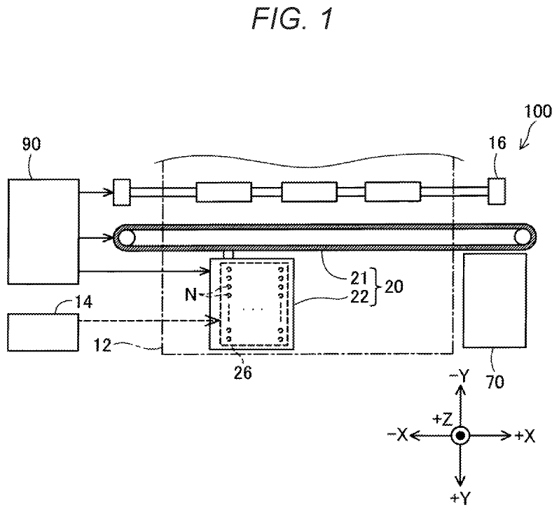

FIG. 1 is a schematic diagram showing a schematic configuration of a liquid ejection apparatus 100 according to an embodiment. The liquid ejection apparatus 100 is an inkjet printing apparatus that performs printing by ejecting droplets of ink as a liquid onto a medium 12. As the medium 12, in addition to printing paper, a printing target of any material such as a resin film or cloth can be adopted. In the following description, an X direction, a Y direction, and a Z direction orthogonal to one another are used. For specification of the direction, positive and negative signs are used with the directions such that “+” is used with a positive direction and “−” is used with a negative direction. In the present embodiment, the X direction is a main scanning direction which is a movement direction of a liquid ejection head 26. The Y direction is a sub-scanning direction that is a medium feeding direction orthogonal to the main scanning direction. The −Z direction is an ejection direction of the ink. In the following description, the +Z direction may be referred to as “upper” and the −Z direction may be referred to as “lower”.

The liquid ejection apparatus 100 includes the liquid ejection head 26, a head moving mechanism 20, a liquid storage unit 14, a conveying mechanism 16, a cleaning device 70, and a controller 90.

The liquid storage unit 14 stores ink to be supplied to the liquid ejection head 26. As the liquid storage unit 14, a bag-shaped liquid pack formed of a flexible film, an ink tank refillable with ink, a detachable ink cartridge, or the like can be used.

The liquid ejection head 26 has a plurality of nozzles N for ejecting ink. The plurality of nozzles N are arranged in the Y direction. The liquid ejection head 26 ejects the ink supplied from the liquid storage unit 14 from the plurality of nozzles N toward the medium 12.

The head moving mechanism 20 includes a conveying belt 21 and a carriage 22 that houses the liquid ejection head 26. The carriage 22 is coupled to the conveying belt 21 and reciprocates in the X direction as the conveying belt 21 is driven. The conveying mechanism 16 conveys the medium 12 in the +Y direction.

The cleaning device 70 removes and cleans deposits DE deposited on the liquid ejection head 26. The deposits DE are typically solidified color materials such as a pigment left after a solvent contained in the ink evaporates. When the deposits DE remain, the nozzle N is blocked by the deposits DE, which causes so-called clogging of ink, ejection of ink deviated from a desired trajectory, and the like. Therefore, it is required to remove the deposits DE from the liquid ejection head 26.

The controller 90 includes one or more processing circuits such as a central processing unit (CPU) or a field programmable gate array (FPGA) and a storage circuit such as a semiconductor memory, and controls the operation of the entire liquid ejection apparatus 100. The controller 90 is electrically coupled to the conveying mechanism 16, the head moving mechanism 20, the liquid ejection head 26, and the cleaning device 70, and controls each unit. The liquid is ejected from the nozzles N onto the medium 12 being conveyed by the conveying mechanism 16, thereby printing an image on the medium 12.

### A2. Configuration of Liquid Ejection Head:

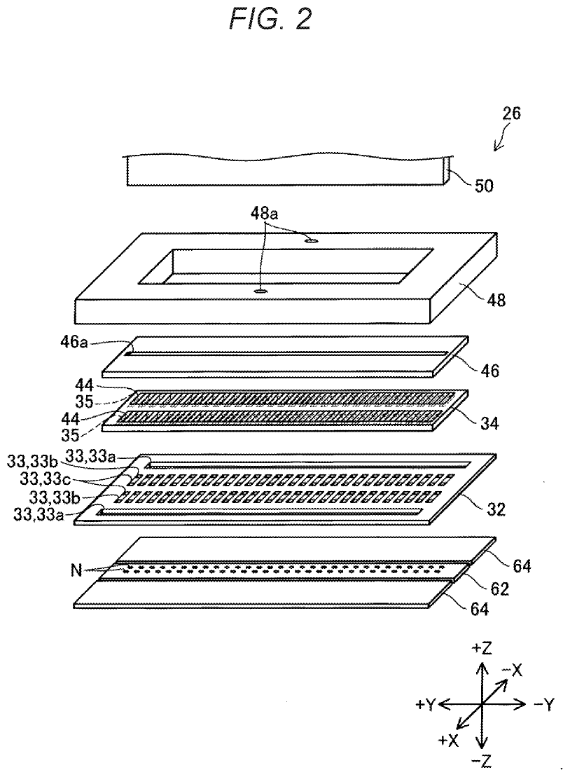

FIG. 2 is an exploded perspective view of the liquid ejection head 26 according to the embodiment. As illustrated in FIG. 2, the liquid ejection head 26 includes a nozzle plate 62, two vibration absorbers 64, a communication substrate 32, a pressure chamber substrate 34, a sealing body 46, a housing portion 48, and a circuit board 50. The nozzle plate 62, the vibration absorbers 64, the communication substrate 32, the pressure chamber substrate 34, and the sealing body 46 are plate-shaped members elongated in the Y direction. Each of the nozzle plate 62, the communication substrate 32, the pressure chamber substrate 34, and the sealing body 46 has a substantially line-symmetric structure with respect to a center line in the X direction. The size of the planar shape of the pressure chamber substrate 34 and the sealing body 46 is smaller than the size of the planar shape of the communication substrate 32 and the housing portion 48. In assembly, the nozzle plate 62 and the two vibration absorbers 64, the communication substrate 32, the pressure chamber substrate 34, the sealing body 46, and the housing portion 48 are stacked in this order and are bonded to each other by, for example, an adhesive.

The nozzle plate 62 is the plate-shaped member on which the plurality of nozzles N are formed. The nozzle N is a through hole having a substantially circular planar shape. The plurality of nozzles N are arranged along the Y direction. There are two rows side by side in the X direction, in which the plurality of nozzles N are arranged. The two vibration absorbers 64 are flexible films and are disposed with the nozzle plate 62 in between in the X direction.

The communication substrate 32 has communication portions 33. The communication portions 33 include two first openings 33a, a plurality of second openings 33b, and a plurality of third openings 33c. The planar shape of the first opening 33a is a quadrangle elongated in the Y direction. The first opening 33a is formed along a side of the communication substrate 32 parallel to the Y direction. The plurality of second openings 33b are arranged in the Y direction. Similarly, the plurality of third openings 33c are arranged in the Y direction. There are two rows of the second openings 33b and two rows of the third openings 33c. In the X direction, the first opening 33a, one row of second openings 33b, one row of third openings 33c, one row of third openings 33c, one row of second openings 33b, and the first opening 33a are formed side by side in this order. Further, the second opening 33b and the third opening 33c adjacent to each other in the X direction are formed such that the positions thereof in the Y direction are substantially the same.

A plurality of openings 35 are formed on a surface of the pressure chamber substrate 34 facing the communication substrate 32. The planar shape of the opening 35 is a quadrangle elongated in the X direction. The plurality of openings 35 are arranged in the Y direction. There are two rows in which the plurality of openings 35 are arranged, and the two rows are formed side by side in the X direction. The opening 35 is formed at a position overlapping the adjacent second opening 33b and third opening 33c formed in the communication substrate 32 when viewed from the Z direction.

Piezoelectric elements 44 are formed on a surface of the pressure chamber substrate 34 facing the sealing body 46. The sealing body 46 reinforces the strength of the pressure chamber substrate 34 and protects the piezoelectric elements 44. The sealing body 46 has a sealing body opening 46a and sealing body recesses. The planar shape of the sealing body opening 46a is a quadrangle elongated in the Y direction. The sealing body recesses are formed to be recessed from a surface of the sealing body 46 facing the piezoelectric element 44.

A drive circuit (not illustrated) for driving the piezoelectric elements 44 is mounted on the circuit board 50. Specifically, the drive circuit is implemented by an integrated circuit (IC) chip that outputs a reference voltage and a drive signal for driving the piezoelectric elements 44. The drive circuit and the piezoelectric elements 44 are electrically coupled via electric wiring (not illustrated).

The housing portion 48 is a case for storing ink and has a frame shape. When stacked, the pressure chamber substrate 34, a diaphragm 36, and the sealing body 46 are disposed in the internal space of the housing portion 48. Through holes 48a are formed at the respective ends of the housing portion 48 in the X direction.

### A3. Configuration of Cleaning Device:

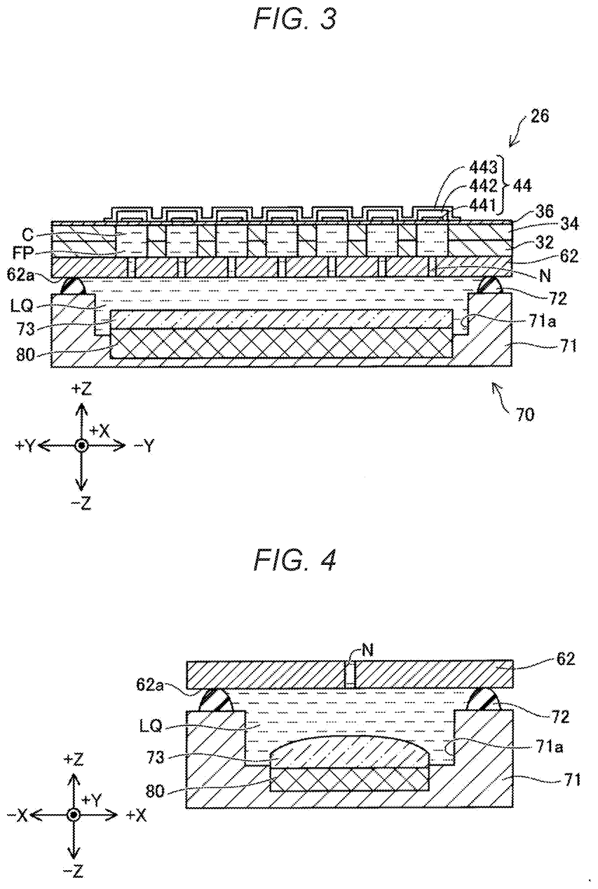

FIG. 3 is a schematic cross-sectional view of a part of the liquid ejection head 26 and the cleaning device 70. FIG. 3 shows a state in which a cap 71 of the cleaning device 70 is attached to the liquid ejection head 26 for cleaning processing. FIG. 3 is a cross-sectional view taken along a plane passing through the center of the nozzles N and being parallel to the YZ plane.

One cap 71 is provided for each nozzle row in which the plurality of nozzles N are arranged in the Y direction. In the following description, one cap 71 corresponding to one nozzle row of the two nozzle rows of the liquid ejection head 26 will be described.

As shown in FIG. 3, the nozzles N are opened in an ejection surface 62a which is one surface of the nozzle plate 62. The communication substrate 32, the pressure chamber substrate 34, and the diaphragm 36 are stacked on a surface of the nozzle plate 62 opposite to the ejection surface 62a. Pressure chambers C and supply flow paths FP from the pressure chambers C to the nozzles N are formed by the pressure chamber substrate 34 and the communication substrate 32. The diaphragm 36 defines the pressure chambers C. Specifically, the pressure chambers C are defined by the sealing body recesses of the pressure chamber substrate 34, and the diaphragm 36 is a part of the pressure chamber substrate 34. The supply flow paths FP are defined by the communication portions 33 of the communication substrate 32. The piezoelectric elements 44 are formed on a surface of the diaphragm 36 opposite to the surface defining the pressure chamber substrate 34.

Each piezoelectric element 44 includes a lower electrode 441, a piezoelectric layer 442, and an upper electrode 443. The lower electrode 441, the piezoelectric layer 442, and the upper electrode 443 are stacked in this order. The lower electrode 441 and the upper electrode 443 contain metals. The piezoelectric layer 442 contains, for example, lead zirconate titanate (PZT). In the present embodiment, in plan view in which the diaphragm 36 is viewed along the Z direction, the upper electrode 443 is not separated for each piezoelectric element 44, and is formed to cover the upper side of the plurality of nozzles N arranged in the Y direction. The lower electrode 441 is separated for each piezoelectric element 44. When a voltage is applied between the lower electrode 441 and the upper electrode 443, the piezoelectric layer 442 is deformed. The diaphragm 36 vibrates with the deformation of the piezoelectric layer 442.

Ink is supplied to the pressure chamber C from a flow path (not illustrated). When the pressure of the pressure chamber C is changed by the vibration of the diaphragm 36, the ink is ejected from the nozzle N.

The cleaning device 70 includes the cap 71, an ultrasonic device 80, and the controller 90. The controller 90 controls not only the cleaning device 70 but also the entire liquid ejection apparatus 100. For example, in the cleaning processing described later, the controller 90 controls the head moving mechanism 20, the cleaning device 70, and the like. Strictly, the controller provided in the cleaning device 70 refers to a functional unit of the controller 90, which performs the cleaning processing described later, but in the description of the present application, the “controller 90” is used without detailed distinction. As described above, in the controller 90, the functional unit that performs the cleaning processing to be described later may be implemented by, for example, the CPU executing a program stored in the storage circuit, that is, by using software, may be implemented by using dedicated hardware such as an FPGA, or may be implemented by using both.

The cap 71 is configured to be movable between an attachment position shown in FIG. 3 where the cap 71 contacts the nozzle plate 62 and a release position where the cap 71 is separated from the nozzle plate 62 by a moving mechanism (not illustrated). When the cleaning processing is performed, the controller 90 moves the liquid ejection head 26 to the placement position of the cap 71. When the liquid ejection head 26 moves to the placement position of the cap 71, the controller 90 moves the cap 71 into contact with the nozzle plate 62.

The cap 71 is disposed to face the ejection surface 62a. The cap 71 has a recess 71a. The cap 71 is configured to store a liquid LQ in a space surrounded by the recess 71a and the ejection surface 62a. Examples of the material of the cap 71 include stainless steel and synthetic resin.

A packing 72 made of an elastic material is provided on the periphery of the cap 71. The material of the packing 72 is, for example, rubber. The packing 72 is provided, and thus leakage of the liquid LQ stored in the recess 71a can be suppressed. The cap 71 is provided with an ejection flow path (not illustrated) for ejection of the stored liquid LQ.

An acoustic lens 73 and the ultrasonic device 80 are disposed to be superimposed on the bottom surface facing the ejection surface 62a among the surfaces defining the recess 71a of the cap 71.

FIG. 4 shows the acoustic lens 73. FIG. 4 is a cross-sectional view taken along a plane passing through the center of the nozzle N and being parallel to the XZ plane. The acoustic lens 73 focuses ultrasonic waves in a lens focusing range (not illustrated) on the ejection surface 62a. The lens focusing range is set in advance to include the plurality of nozzles N. The lens focusing range has a predetermined length in the X direction as a second direction. Specifically, as illustrated in FIG. 4, among the surfaces of the acoustic lens 73, the surface facing the nozzle N is a curved surface curved along the X direction and being convex toward the nozzle N. The acoustic lens 73 is fabricated so as to form a propagation path of ultrasonic waves such that the ultrasonic waves transmitted from the ultrasonic device 80 are focused in the lens focusing range when the ultrasonic waves transmitted from the ultrasonic device 80 enter.

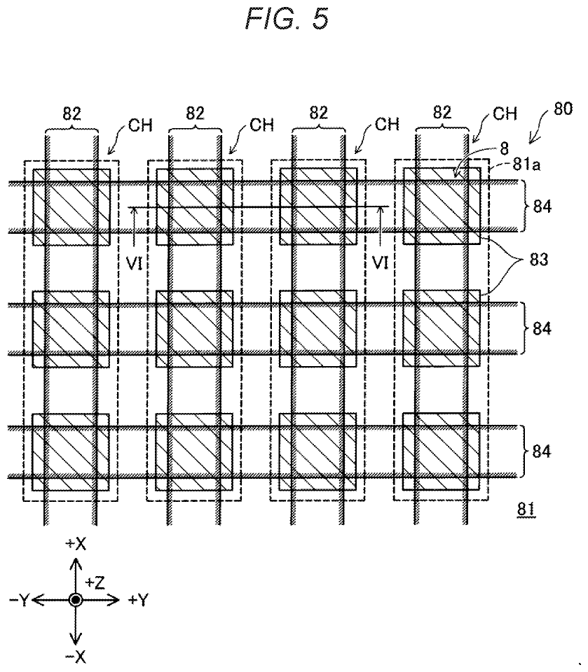

FIG. 5 is a plan view of the ultrasonic device 80. The ultrasonic device 80 includes a substrate 81, a plurality of first electrodes 82, a plurality of piezoelectric elements 83, and a plurality of second electrodes 84. The first electrodes 82, the piezoelectric elements 83, and the second electrodes 84 are sequentially stacked on the substrate 81. The first electrode 82 and the second electrode 84 contain metals. The piezoelectric element 83 contains, for example, lead zirconate titanate.

In the present embodiment, the shape of each first electrode 82 in plan view viewed along the Z direction is a rectangle long in the X direction. The shape of each second electrode 84 in plan view is a rectangle elongated in the Y direction. The respective first electrodes 82 and second electrodes 84 are routed to ends of the substrate 81. The respective first electrodes 82 and second electrodes 84 are electrically coupled to terminals formed at the ends of the substrate 81 for electrical coupling to a drive circuit for the ultrasonic device 80 provided in the controller 90.

Although not illustrated in FIG. 5, in the present embodiment, the plurality of second electrodes 84 are electrically coupled to one another at the ends of the substrate 81. When the ultrasonic device 80 is controlled, a common voltage is applied to the plurality of second electrodes 84. In contrast, individual voltages independent of one another are applied to the plurality of first electrodes 82. Therefore, the first electrode 82 is also referred to as an individual electrode, and the second electrode 84 is also referred to as a common electrode. The piezoelectric element 83 is formed in a range in which the first electrode 82 and the second electrode 84 overlap. A portion in which the first electrode 82, the piezoelectric element 83, and the second electrode 84 overlap is referred to as an ultrasonic vibrator 8.

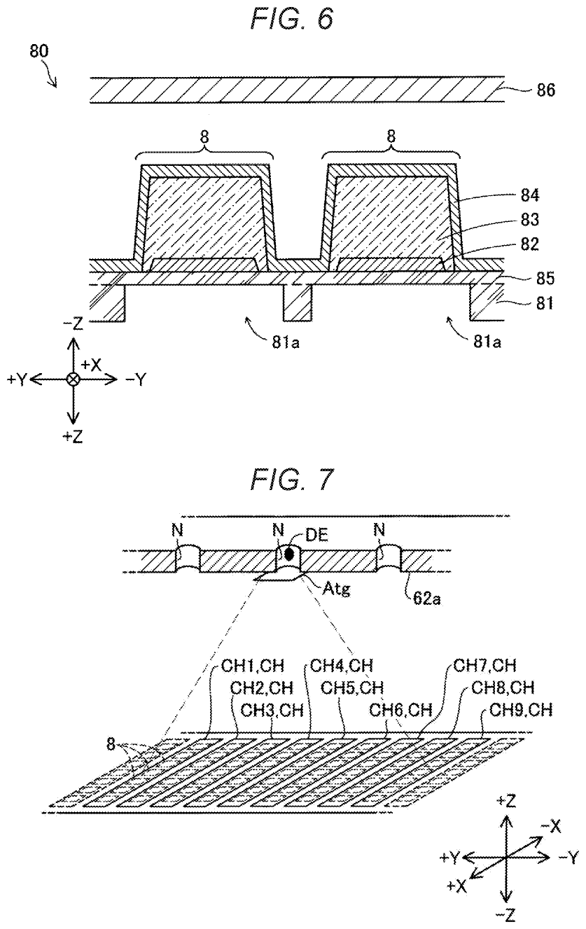

FIG. 6 is a cross-sectional view taken along line VI-VI in FIG. 5. As shown in FIG. 6, the ultrasonic device 80 has a diaphragm 85 and a sealing plate 86 in addition to the above-described configuration. Openings 81a are formed in the substrate 81. The diaphragm 85 is disposed between the substrate 81 and the first electrodes 82. The sealing plate 86 is disposed above the ultrasonic vibrators 8 so as to cover the ultrasonic vibrators 8. The sealing plate 86 is provided with column portions (not illustrated) protruding downward for coupling to the diaphragm 85. The sealing plate 86 is fixed to the diaphragm 85 by the column portions.

In FIG. 6, the ultrasonic device 80 is illustrated in an arrangement mode in which the distance between the substrate 81 and the acoustic lens 73 is shorter than the distance between the sealing plate 86 and the acoustic lens 73, but the arrangement mode of the ultrasonic device 80 is not limited thereto. The ultrasonic device 80 may be disposed on the cap 71 in an arrangement mode in which the distance between the sealing plate 86 and the acoustic lens 73 is shorter than the distance between the substrate 81 and the acoustic lens 73, that is, in an arrangement mode vertically inverted from FIG. 6.

When a voltage is applied between the first electrode 82 and the second electrode 84, the piezoelectric element 83 is deformed, the diaphragm 85 vibrates, and ultrasonic waves are transmitted. As described above, in the present embodiment, the first electrode 82 is the individual electrode, and the second electrode 84 is the common electrode. As shown in FIG. 5, among the plurality of ultrasonic vibrators 8, a group of ultrasonic vibrators 8 sharing the same first electrode 82 is referred to as a “channel CH”.

FIG. 7 is a perspective view showing a relationship between the channels CH and the nozzles N. As shown in FIG. 7, the plurality of channels CH are arranged in the Y direction as a first direction. The arrangement direction of the plurality of channels CH coincides with the arrangement direction of the nozzles N. Accordingly, by shifting the transmission timing of ultrasonic burst waves transmitted from the plurality of channels CH from one another, the ultrasonic waves can be focused on the target nozzle N among the plurality of nozzles N.

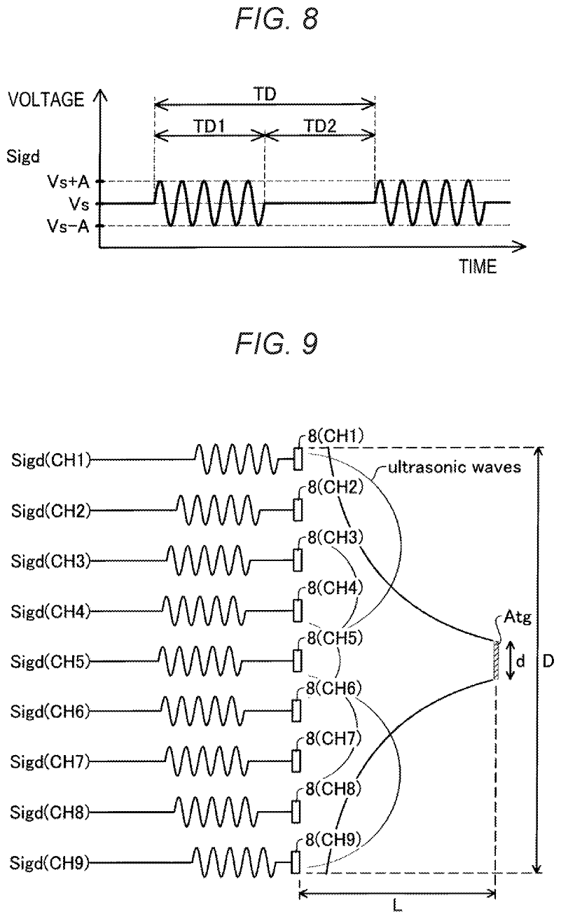

FIG. 8 is a waveform diagram of a burst signal Sigd applied to the individual electrode. As illustrated in FIG. 8, the burst signal Sigd is a burst signal in which a first period TD1 in which a sine wave is transmitted and a second period TD2 in which a DC voltage is transmitted are repeated in a cycle TD. The sine wave in the first period TD1 is a sine wave having amplitude A at the center voltage of the amplitude as a reference voltage Vs. The voltage in the second period TD2 is the reference voltage Vs. In the present embodiment, the frequency of the sine wave in the first period TD1 is 1 MHz or more. Accordingly, as will be described in detail later, the range in which the ultrasonic wave converges can be narrowed.

The controller 90 inputs the burst signal Sigd to the ultrasonic vibrator 8 to control the ultrasonic device 80. When the reference voltage Vs is applied to the second electrode 84 of the ultrasonic vibrator 8 and the burst signal Sigd is input to the first electrode 82 of the ultrasonic vibrator 8, the ultrasonic vibrator 8 transmits ultrasonic burst waves. The ultrasonic burst waves are ultrasonic waves for which a period in which the ultrasonic waves are transmitted and a period in which the transmission of the ultrasonic waves is stopped are repeated in a cycle TD.

FIG. 9 shows a relationship between the burst signals Sigd input to the plurality of channels CH and the ultrasonic waves transmitted from the plurality of channels CH. FIG. 9 illustrates a case where a target range Atg in which ultrasonic waves are to be focused is on a fifth channel CH5 as an example. In the following description, for ease of understanding, a case where nine channels CH from the first channel CH1 to the ninth channel CH9 are controlled in order to focus the ultrasonic waves in the target range Atg will be described as an example.

The controller 90 performs control such that the transmission time when the ultrasonic vibrator 8 transmits ultrasonic waves is shifted according to the distance between the target range Atg and the ultrasonic vibrator 8. The distance between the target range Atg and the ultrasonic vibrator 8 is the distance between the center of the target range Atg and the center of the ultrasonic vibrator 8. As illustrated in FIG. 9, the controller 90 controls the plurality of ultrasonic vibrators 8 such that the transmission time of the burst waves transmitted from the fifth channel CH5 among the plurality of channels CH is the latest and the transmission time of the burst waves is shifted according to the arrangement direction of the plurality of channels CH. Specifically, the controller 90 sets the start time of the first period TD1 of each burst signal Sigd to be later in the order of the first channel CH1, the second channel CH2, the third channel CH3, the fourth channel CH4, and the fifth channel CH5, and to be earlier in the order of the fifth channel CH5, the sixth channel CH6, the seventh channel CH7, the eighth channel CH8, and the ninth channel CH9. As a result, the ultrasonic waves transmitted from the channels CH are superimposed in the target range Atg and become ultrasonic waves having larger amplitude. As described above, the controller 90 focuses the ultrasonic waves in the target range Atg by performing control such that the transmission time when each of the plurality of ultrasonic vibrators 8 transmits the burst waves is shifted according to the first direction.

In general, when the diameter of the range in which the ultrasonic waves are transmitted is D [m], the diameter of the range in which the ultrasonic waves are focused is d [m], the distance from the range in which the ultrasonic waves are transmitted to the range in which the ultrasonic waves are focused is L [m], and the frequency of the ultrasonic waves is f [Hz], the beam diameter d is expressed by the following Expression (1). In Expression (1), “c” is the sound velocity [m/s].

d=(1.02×L×c)/(D×f) (1)

As shown in Expression (1), the beam diameter d can be reduced as the frequency of the ultrasonic wave is increased. In the present embodiment, the beam diameter d can be made smaller by setting the frequency of the ultrasonic wave to 1 MHz or more. The beam diameter d in the present embodiment is about 200 μm. The diameter of the nozzle N is about 20 μm.

### A4. Cleaning Processing:

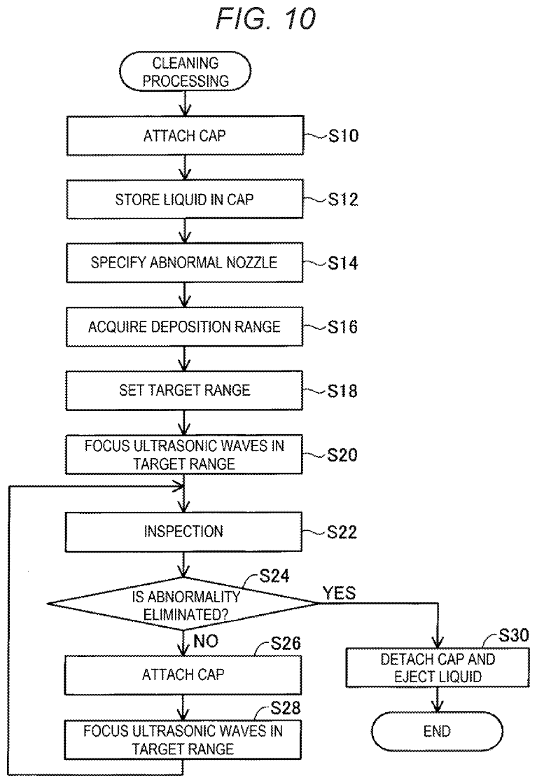

FIG. 10 is a flowchart showing a procedure of the cleaning processing. A user who uses the liquid ejection apparatus 100 instructs the liquid ejection apparatus 100 to perform cleaning via an interface (not illustrated), for example, when the user views a printed matter and the printing quality is not good. Upon receiving the cleaning instruction, the controller 90 performs the cleaning processing.

In step S10 of FIG. 10, the controller 90 moves the liquid ejection head 26 to the position of the cleaning device 70 and moves the cap 71 so that the cap 71 comes into close contact with the ejection surface 62a, thereby attaching the cap 71 to the liquid ejection head 26.

In step S12, the controller 90 stores the liquid in the recess 71a of the cap 71. In the present embodiment, the controller 90 causes the liquid ejection head 26 to eject ink to fill a space surrounded by the ejection surface 62a and the recess 71a with ink. As another embodiment, the liquid stored in the cap 71 may be pure water or a cleaning liquid instead of the printing ink.

In step S14, the controller 90 specifies an abnormal nozzle having an ejection abnormality in which normal ejection is not performed among the plurality of nozzles N. The cases in which normal ejection is not performed include a case in which ejection of a predetermined amount of ink designated by the controller 90 is not performed, a case in which ink is not ejected at a desired speed, and a case in which ejected ink does not fly in a desired flight path and ink is landed at a position deviated from a desired landing position on the medium 12.

In the present embodiment, the controller 90 detects a residual vibration when the ink is ejected in step S12, and specifies the abnormal nozzle by comparing the detected residual vibration with a predetermined reference vibration. The residual vibration is a vibration of the piezoelectric element 44 after a drive voltage for ejection is applied to the piezoelectric element 44 of the liquid ejection head 26.

Specifically, a detection wire for detecting the residual vibration is electrically coupled to the upper electrode 443 separately from a drive wire for applying the drive voltage. The residual vibration is converted into a voltage by the piezoelectric layer 442. Therefore, the controller 90 detects the residual vibration by detecting the fluctuations of the voltage of the detection wire after the drive voltage is applied.

The residual vibration varies depending on the volume of the pressure chamber C, the weight of the ink, and the like. Therefore, when the deposits DE are deposited inside of the nozzle N or the periphery of the nozzle N on the ejection surface 62a, for example, the cycle of the residual vibration shifts from the cycle of the reference vibration. In the present embodiment, the controller 90 determines that the target nozzle N is abnormal when the cycle of the residual vibration of the target nozzle N is outside a predetermined reference cycle range.

In step S16, the controller 90 acquires a deposition range including the abnormal nozzle specified in step S14 as the deposition range in which the deposits DE are deposited. In step S18, the controller 90 sets the target range Atg using the deposition range. In the present embodiment, the controller 90 sets a range including the deposition range as the target range Atg. As shown in FIG. 7, when the range including the nozzle N is set as the target range Atg, the range including the nozzle N on the same plane as the ejection surface 62a is set as the target range Atg in the plan view in which the nozzle plate 62 is viewed from the direction perpendicular to the nozzle plate 62.

For ease of understanding, the target range Atg illustrated in FIG. 7 indicates a range after the ultrasonic waves transmitted by the ultrasonic vibrator 8 are further focused by the acoustic lens 73. In the present embodiment, if the acoustic lens 73 is not provided, the ultrasonic waves transmitted from the ultrasonic device 80 are not focused with respect to the X direction. Therefore, specifically, in step S18, the controller 90 sets the position range in the Y direction on the ejection surface 62a as the target range Atg.

In step S20, the controller 90 causes the ultrasonic device 80 provided in the channel CH to transmit ultrasonic waves so that the ultrasonic waves are focused in the target range Atg. Specifically, the controller 90 inputs the burst signal Sigd to the ultrasonic vibrator 8 and causes the ultrasonic vibrator 8 to transmit burst waves. As described above, the burst signal Sigd input to the ultrasonic vibrator 8 of each of the first channel CH1 to the ninth channel CH9 is adjusted such that the transmission time of the burst waves is shifted according to the first direction. The ultrasonic waves transmitted from the ultrasonic device 80 propagate through the acoustic lens 73, then propagate through the liquid LQ stored in the cap 71, and are focused in the target range Atg.

The deposits DE are removed from the nozzle plate 62 by the acoustic radiation force of the ultrasonic waves focused in the target range Atg or shock waves when bubbles generated by cavitation disappear. Specifically, the ultrasonic waves are focused in the target range Atg, and thus cavitation occurs near the target range Atg. The bubbles generated by the cavitation disappear after repeating contraction and expansion. High pressure is applied to the deposits DE by the shock waves generated when the bubbles disappear, and the deposits DE are removed from the nozzle plate 62.

Unlike the present embodiment, when continuous waves are transmitted from the ultrasonic device 80, standing waves of ultrasonic waves are generated in the liquid LQ between the ultrasonic device 80 and the ejection surface 62a. The sound pressure at the antinode of the standing waves is high, but the sound pressure at the node of the standing waves is low. Therefore, a portion where cavitation is likely to occur and a portion where cavitation is unlikely to occur are generated in the entire liquid LQ, and cleaning unevenness is likely to occur. In this regard, according to the present embodiment, since the ultrasonic waves are selectively focused in the target range Atg, the portion on which the deposits DE are deposited can be efficiently cleaned.

Furthermore, unlike the present embodiment, when the continuous waves are transmitted from the ultrasonic device 80 and the frequency of the ultrasonic waves is from about 15 kHz to 100 kHz, the interval at which the cavitation occurs is longer. When the frequency of the ultrasonic waves is from about 15 kHz to 100 kHz, the diameters of the bubbles resonating with the ultrasonic waves among the bubbles generated by the cavitation are larger. Therefore, cleaning unevenness is likely to occur. In this regard, according to the present embodiment, since the diameter of the target range Atg can be made smaller by setting the frequency of the ultrasonic waves to 1 MHz or more, the portion on which the deposits DE are deposited can be efficiently cleaned.

It is also known that when ultrasonic waves are transmitted to an object, the object is damaged. According to the present embodiment, since the ultrasonic waves are focused selectively in the target range Atg, it is possible to limit the range in which the nozzle plate 62 is damaged. Therefore, it is possible to reduce damage on the nozzle plate 62 due to the transmission of the ultrasonic waves and to suppress deterioration of the liquid ejection head 26.

In step S22, the controller 90 inspects whether the ejection abnormality of the abnormal nozzle is eliminated. In the present embodiment, after temporarily moving the cap 71 to the release position, the controller 90 performs the inspection using the residual vibration when the ink is ejected from the nozzle N, similarly to step S14.

In step S24, the controller 90 determines whether the ejection abnormality of the abnormal nozzle is eliminated. When determining that the ejection abnormality of the abnormal nozzle is not eliminated in step S24, the controller 90 moves the cap 71 to the attachment position in step S26. In step S28, similarly to step S20, the controller 90 causes the ultrasonic device 80 to transmit ultrasonic waves so that the ultrasonic waves are focused in the target range Atg. In step S28, after the cap 71 is attached, processing of filling the space surrounded by the ejection surface 62a and the recess 71a with ink may be performed by ejecting ink from the liquid ejection head 26.

After performing step S28, the controller 90 returns the processing step to step S22 in order to confirm whether the ejection abnormality of the abnormal nozzle is eliminated. When determining that the ejection abnormality of the abnormal nozzle is eliminated in step S24, the controller 90 moves the cap 71 to the release position and detaches the cap, ejects the liquid LQ stored in the recess 71a of the cap 71 using a liquid ejection flow path (not illustrated) in step S30, and ends the processing routine.

According to the first embodiment described above, the cleaning device 70 has the cap 71, the ultrasonic device 80, and the controller 90. The ultrasonic device 80 includes the plurality of ultrasonic vibrators 8 arranged in the first direction. In step S16, the controller 90 acquires the deposition range in which the deposits DE are deposited, and in step S18, sets the target range Atg using the deposition range. In step S20, the controller 90 focuses the ultrasonic waves in the target range Atg. As a result, since the ultrasonic waves are selectively focused in the target range Atg, the portion on which the deposits DE are deposited can be efficiently cleaned.

Furthermore, in step S20, the controller 90 performs control such that the transmission time when the ultrasonic vibrator 8 transmits the ultrasonic waves is shifted according to the distance between the target range Atg and the ultrasonic vibrator 8. As a result, ultrasonic waves having higher sound pressure can be transmitted to the target range Atg.

After focusing the ultrasonic waves in the target range Atg in step S20, when determining that the ejection abnormality of the abnormal nozzle is not eliminated in step S24, the controller 90 focuses the ultrasonic waves again in the target range Atg in step S28. Accordingly, the ultrasonic waves can be repeatedly focused in the target range Atg until the ejection abnormality of the abnormal nozzle is eliminated.

### B. Second Embodiment

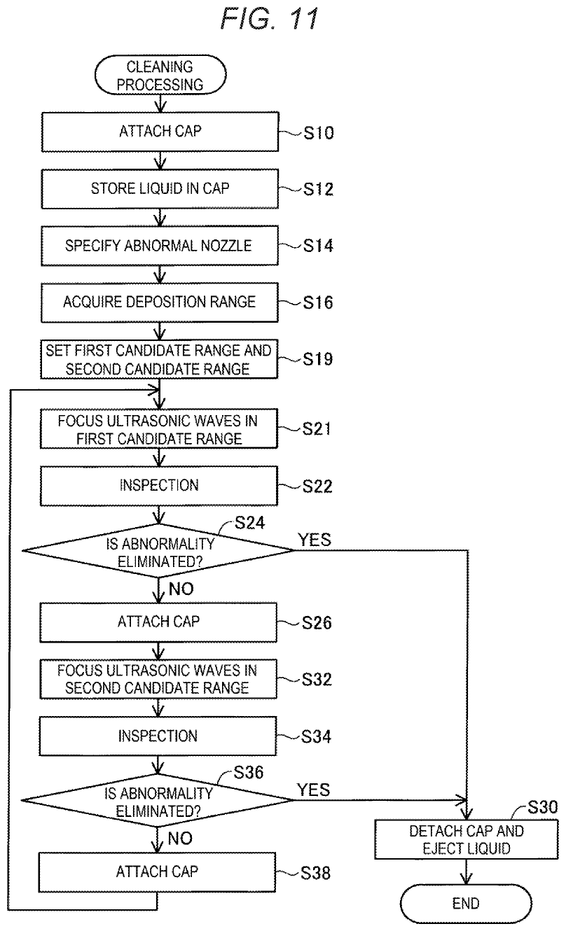

FIG. 11 is a flowchart illustrating a procedure of cleaning processing according to a second embodiment. In the first embodiment, the single target range Atg is set for the abnormal nozzle. In contrast, in the second embodiment, two target ranges Atg are set for an abnormal nozzle. The same configurations and processing steps as those of the first embodiment are denoted by the same signs, and the detailed description thereof will be omitted as appropriate.

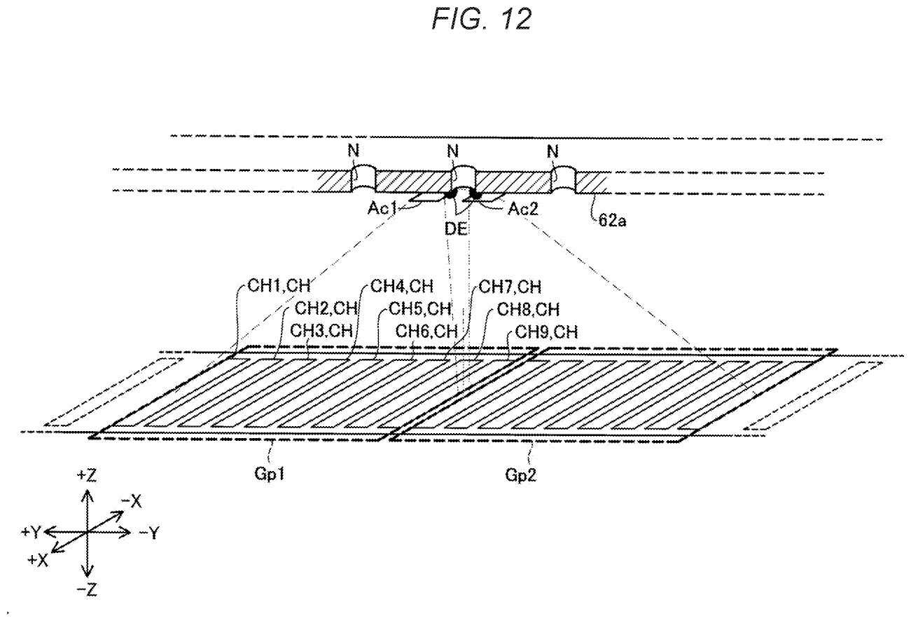

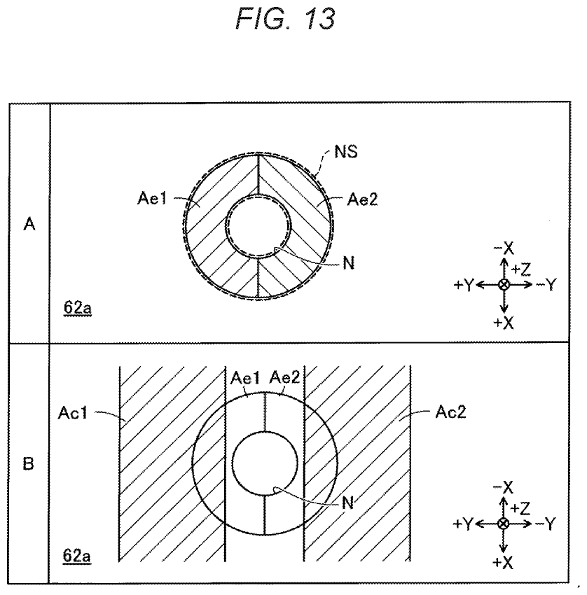

FIG. 12 shows a correspondence relationship between a first candidate range Ac1 and a second candidate range Ac2 and a first group Gp1 and a second group Gp2. As illustrated in FIG. 12, in the present embodiment, it is assumed that the deposits DE are deposited not inside of the nozzle N but at a position on the ejection surface 62a surrounding the nozzle N. Therefore, in the present embodiment, a position near the nozzle N on the ejection surface 62a is set as a target range Atg.

As illustrated in FIG. 11, the controller 90 performs steps S10 to S16 similarly to the first embodiment. In step S19, the controller 90 sets the first candidate range Ac1 and the second candidate range Ac2 using the deposition range.

In the present embodiment, a deposition range including the abnormal nozzle is acquired as the deposition range. Since the abnormal nozzle is specified using the residual vibration, it is not possible to specify the position where the deposits DE are deposited on the ejection surface 62a. Therefore, in the present embodiment, the first candidate range Ac1 and the second candidate range Ac2 facing each other in the direction in which the nozzles N are arranged with the abnormal nozzle N in between are set as candidates of the target range Atg.

FIG. 13 shows the ejection surface 62a for illustrating the first candidate range Ac1 and the second candidate range Ac2. As indicated by “A” in FIG. 13, the controller 90 first sets a first range Ae1 and a second range Ae2 obtained by dividing a nozzle periphery NS which is a range on the ejection surface 62a surrounding the nozzle N having the ejection abnormality. In the present embodiment, the controller 90 sets the first range Ae1 and the second range Ae2 by dividing the nozzle periphery NS by a dividing line parallel to the X direction as the direction passing through the center of the nozzle N and perpendicular to the arrangement direction of the channels CH. Then, as indicated by “B” in FIG. 13, the controller 90 sets the first candidate range Ac1 including at least a part of the first range Ae1, but not including the second range Ae2 and the second candidate range Ac2 including at least a part of the second range Ae2, but not including the first range Ae1 as candidates for the target range Atg.

In step S21 of FIG. 11, the controller 90 sets the first candidate range Ac1 as the target range Atg, and focuses the ultrasonic waves in the target range Atg. As shown in FIG. 12, in the present embodiment, the plurality of ultrasonic vibrators 8, the first group Gp1 of ultrasonic vibrators 8 for focusing the ultrasonic waves in the first candidate range Ac1 and the second group Gp2 of ultrasonic vibrators 8 for focusing the ultrasonic waves in the second candidate range Ac2 are determined in advance. The ultrasonic vibrators 8 of the first group Gp1 are the ultrasonic vibrators 8 disposed below the first candidate range Ac1. The ultrasonic vibrators 8 of the second group Gp2 are the ultrasonic vibrators 8 disposed below the second candidate range Ac2.

In step S21, the controller 90 causes the ultrasonic devices 80 of the first group Gp1 to transmit ultrasonic waves so that the ultrasonic waves converge in the first candidate range Ac1. Accordingly, the deposits DE near the first candidate range Ac1 are removed. In step S22, the controller 90 inspects whether the ejection abnormality of the abnormal nozzle is eliminated. In step S24, the controller 90 determines whether the ejection abnormality of the abnormal nozzle is eliminated. When determining that the ejection abnormality of the abnormal nozzle is not eliminated in step S24, the controller 90 moves the cap 71 to the attachment position and attaches the cap 71 to the ejection surface 62a in step S26.

In step S32, the controller 90 sets the second candidate range Ac2 as the target range Atg, and focuses the ultrasonic waves in the target range Atg. In the present embodiment, the controller 90 causes the ultrasonic devices 80 of the second group Gp2 to transmit ultrasonic waves and focus the ultrasonic waves in the second candidate range Ac2. Accordingly, the deposits DE near the second candidate range Ac2 are removed.

In step S34, similarly to step S22, the controller 90 inspects whether the ejection abnormality of the abnormal nozzle is eliminated. In step S36, the controller 90 determines whether the ejection abnormality of the abnormal nozzle is eliminated. When determining that the ejection abnormality of the abnormal nozzle is not eliminated in step S36, the controller 90 moves the cap 71 to the attachment position and attaches the cap, and then returns the processing step to step S21 in step S38. Accordingly, the ultrasonic waves are transmitted until it is determined that the ejection abnormality of the abnormal nozzle is eliminated.

When the controller 90 determines that the ejection abnormality is eliminated in step S24 and when the controller 90 determines that the ejection abnormality is eliminated in step S36, the controller 90 advances the processing step to step S30. The controller 90 moves the cap 71 to the release position and detaches the cap, ejects the liquid LQ stored in the recess 71a of the cap 71 in step S30, and ends the present processing routine.

In the present embodiment, the ultrasonic waves are not transmitted to a range including the nozzle N between the first candidate range Ac1 and the second candidate range Ac2. As another embodiment, a processing step of setting a range including the nozzle N between the first candidate range Ac1 and the second candidate range Ac2 as the target range Atg and transmitting ultrasonic waves may be added. Accordingly, the deposits DE deposited inside of the nozzle N can be removed.

According to the second embodiment described above, the controller 90 sets the first range Ae1 and the second range Ae2 in which the nozzle periphery NS is divided. Then, the controller 90 sets the first candidate range Ac1 including at least a part of the first range Ae1, but not including the second range Ae2 and the second candidate range Ac2 including at least a part of the second range Ae2, but not including the first range Ae1 as candidates for the target range Atg. The controller 90 sets each of the first candidate range Ac1 and the second candidate range Ac2 as the target range Atg. Accordingly, since the limited range is set as the target range Atg, it is possible to reduce damage on the liquid ejection head 26 caused by the ultrasonic waves.

After setting the first candidate range Ac1 as the target range Atg and focusing the ultrasonic waves, the controller 90 sets the second candidate range Ac2 as the target range Atg and focuses the ultrasonic waves when the abnormal ejection is not eliminated. As a result, when the ejection abnormality is eliminated by focusing the ultrasonic waves in the first candidate range Ac1 and removing the deposits DE, the processing of focusing the ultrasonic waves in the second candidate range Ac2 can be omitted.

### C. Third Embodiment

The present embodiment is different from the second embodiment in the method of setting the first candidate range Ac1 and the second candidate range Ac2. Therefore, this difference will be described, and the other description will be omitted. In the second embodiment, the first candidate range Ac1 and the second candidate range Ac2 are set as ranges obtained by dividing the nozzle periphery NS. In the present embodiment, the first candidate range Ac1 and the second candidate range Ac2 are set to avoid a range near the nozzle N in the nozzle periphery NS. The same configurations and processing steps as those of the second embodiment are denoted by the same signs, and the detailed description thereof will be omitted as appropriate.

Also in the present embodiment, similarly to the second embodiment, it is assumed that the deposits DE are deposited not inside of the nozzle N but at a position on the ejection surface 62a surrounding the nozzle N.

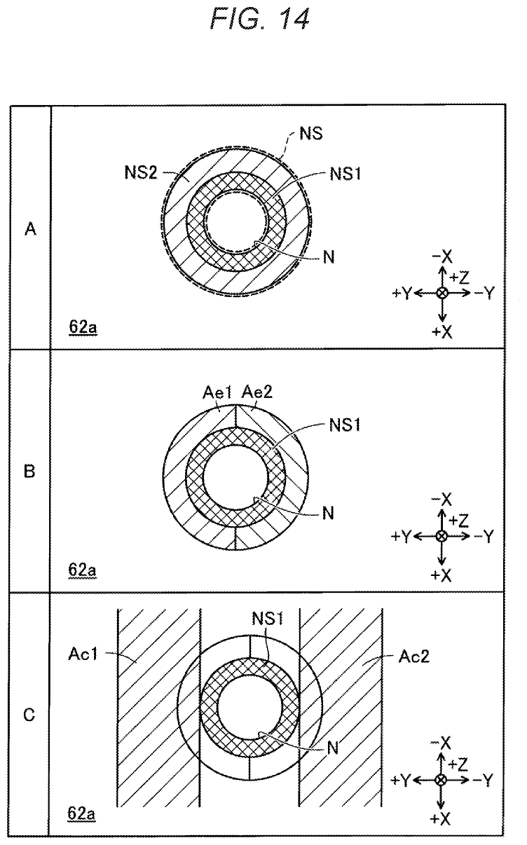

FIG. 14 shows the ejection surface 62a for illustrating the first candidate range Ac1 and the second candidate range Ac2. As indicated by “A” in FIG. 14, the controller 90 further divides the nozzle periphery NS to set a first nozzle periphery NS1 surrounding the nozzle N and a second nozzle periphery NS2 surrounding the first nozzle periphery NS1. Then, as indicated by “B” in FIG. 14, the controller 90 sets a first range Ae1 and a second range Ae2 by dividing the second nozzle periphery NS2. Then, as indicated by “C” in FIG. 14, the controller 90 sets a first candidate range Ac1 including at least a part of the first range Ae1, but not including the first nozzle periphery NS1 and the second range Ae2 and a second candidate range Ac2 including at least a part of the second range Ae2, but not including the first nozzle periphery NS1 and the first range Ae1 as candidates for the target range Atg. Accordingly, the first nozzle periphery NS1 which is a range near the nozzle N on the ejection surface 62a is excluded from the target range Atg. The width of the first nozzle periphery NS1 is, for example, about several micrometers.

Among the deposits DE deposited on the ejection surface 62a, the deposits DE that cause an ejection abnormality are the deposits DE deposited on the first nozzle periphery NS1 as the range near the nozzle N on the ejection surface 62a. That is, the ejection abnormality can be efficiently eliminated by removing the deposits DE deposited on the first nozzle periphery NS1. The size of the deposits DE is about several micrometers.

In general, it is considered that a force acting on particles attached to the surface of an object includes a rotational force for rotating the particles, a sliding force for sliding the particles along the surface, and a lifting force for lifting the particles in a direction away from the surface. It is considered that, when a shear flow having a velocity gradient along a direction perpendicular to the surface is applied to the particles, among the three forces, the rotational force acts s dominantly on the particles and the particles are easily removed from the surface of the object.

Here, the deposits DE of the present disclosure are typically coloring materials, and the deposits DE can be modeled into particles. In the present embodiment, as described above, the range deviated from the first nozzle periphery NS1 is set as the target range Atg. Accordingly, the ultrasonic waves focused in the target range Atg are reflected by the ejection surface 62a, and a shear flow is generated near the ejection surface 62a. As described above, the shear flow generates a rotational force on the deposits DE. Therefore, by setting the range deviated from the first nozzle periphery NS1 as the target range Atg, it is possible to increase the force of removing the deposits DE deposited on the first nozzle periphery NS1.

According to the third embodiment described above, the controller 90 sets the range not including the first nozzle periphery NS1 but including at least a part of the second nozzle periphery NS2 as the target range Atg. As a result, the ultrasonic waves are focused at a position deviated from the deposits DE deposited on the first nozzle periphery NS1. Therefore, since the shear flow can act on the deposits DE, the deposits DE deposited on the first nozzle periphery NS1 can be efficiently removed.

### D. Fourth Embodiment

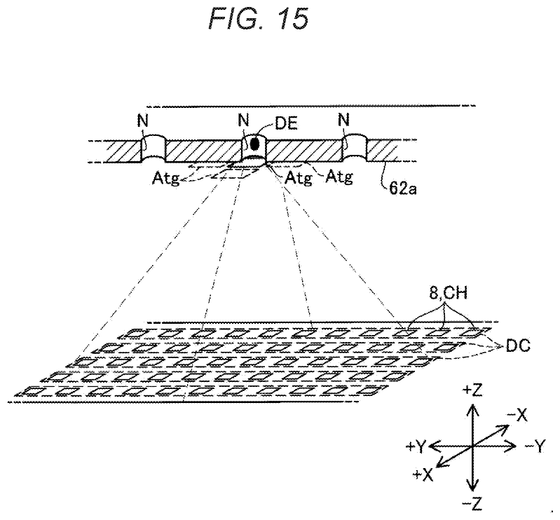

FIG. 15 is a perspective view showing a relationship between channels CH and nozzles N of the present embodiment. The ultrasonic device 80 of the first embodiment has a configuration in which the channels CH as groups of independently controllable ultrasonic vibrators 8 are arranged only in one direction. In contrast, the channels CH of the present embodiment are arranged in a matrix. In the present embodiment, the ultrasonic device 80 does not include the acoustic lens 73.

As shown in FIG. 15, the ultrasonic device 80 of the present embodiment includes a plurality of ultrasonic vibrator arrays DC each including a plurality of ultrasonic vibrators 8 arranged in a first direction. The ultrasonic vibrator arrays DC are arranged in a second direction intersecting the first direction, but not intersecting the ejection surface 62a at a right angle. In the present embodiment, the first direction coincides with the Y direction, and the second direction coincides with the X direction.

In the present embodiment, one channel CH includes one ultrasonic vibrator 8. In the first embodiment, the plurality of second electrodes 84 are electrically coupled to each other to form the channel CH. In contrast, the second electrodes 84 of the present embodiment are not electrically coupled to each other, and are configured to be controllable independently of each other.

The controller 90 focuses the ultrasonic waves in the target range Atg by synchronizing the transmission time of the ultrasonic vibrators 8 arranged in the first direction with the transmission time of the ultrasonic vibrators 8 arranged in the second direction.

Typically, the controller 90 performs control such that the transmission timing of the ultrasonic vibrators 8 at the same distance from the target range Atg are the same. Accordingly, the target range Atg can be set at a desired position not only in the direction in which the nozzles N are arranged on the ejection surface 62a but also in the direction intersecting the direction in which the nozzles N are arranged.

According to the fourth embodiment described above, the controller 90 focuses the ultrasonic waves in the target range Atg by synchronizing the transmission time of the ultrasonic vibrators 8 arranged in the first direction with the transmission time of the ultrasonic vibrators 8 arranged in the second direction. Accordingly, even in a configuration in which the ultrasonic device 80 does not include the acoustic lens 73, the target range Atg can be set at a desired position not only in the direction in which the nozzles N are arranged on the ejection surface 62a but also in the direction intersecting the direction in which the nozzles N are arranged.

### E. Other Embodiments

(E1) In the first embodiment described above, ultrasonic waves having a frequency of 1 MHz or more are used. As another embodiment, ultrasonic waves having a frequency of 10 kHz or more and less than 1 MHz may be used. Furthermore, in the first embodiment, the waveform of the burst signal Sigd in the first period TD1 is the sine wave, but the waveform is not limited to the sine wave. The waveform of the burst signal Sigd in the first period TD1 may be, for example, a rectangular wave.
(E2) In the first embodiment described above, in order to focus the ultrasonic waves in the target range Atg, the plurality of ultrasonic vibrators 8 are controlled such that the transmission time is shifted according to the first direction. As another embodiment, for example, at least two ultrasonic vibrators 8 may be controlled such that the transmission timing of the at least two ultrasonic vibrators 8 of the plurality of ultrasonic vibrators 8 are shifted from each other. Specifically, for example, the same burst signal Sigd may be input to two adjacent ultrasonic vibrators 8. At least two ultrasonic vibrators 8 among the plurality of ultrasonic vibrators 8 are controlled so that the transmission timing of the burst waves are shifted from each other, and thus the ultrasonic waves can be focused in the target range Atg.
(E3) In the first embodiment described above, the controller 90 specifies the abnormal nozzle and acquires a range including the specified abnormal nozzle as the deposition range. In the first embodiment, the residual vibration after ejection of the ink is used to specify the abnormal nozzle. As another embodiment of specifying the abnormal nozzle, the controller 90 may specify the abnormal nozzle using a captured image obtained by imaging a printed matter with a camera. For example, when the deposition position of the deposits DE can be specified using the captured image of the printed matter, the controller 90 may acquire the deposition position as the deposition range instead of the abnormal nozzle. Alternatively, the controller 90 may acquire the deposition position of the deposits DE specified using the captured image obtained by imaging the nozzle plate 62 with the camera as the deposition range. For example, when a position where the deposits DE are likely to be deposited is statistically obtained depending on the position of the nozzle plate 62, the controller 90 may acquire the position as the deposition range. Specifically, for example, the deposition range may be stored in advance in a storage circuit of the controller 90, and the controller 90 may acquire the deposition range by referring to the storage circuit.
(E4) In the second embodiment described above, the controller 90 controls the ultrasonic vibrators 8 of the first group Gp1 when transmitting ultrasonic waves to the first candidate range Ac1, and controls the ultrasonic vibrators 8 of the second group Gp2 when transmitting ultrasonic waves to the second candidate range Ac2. Then, after transmitting the ultrasonic waves to the first candidate range Ac1, the controller 90 performs control to transmit the ultrasonic waves to the second candidate range Ac2. As another embodiment, the controller 90 may control the ultrasonic device 80 to transmit the ultrasonic waves to the first candidate range Ac1 and transmit the ultrasonic waves to the second candidate range Ac2 at the same time. Accordingly, the deposits DE can be removed in a short time.
(E5) In the first embodiment described above, the liquid LQ ejected from the nozzle N is stored in the recess 71a of the cap 71. As another embodiment, the recess 71a may include a supply flow path to which the liquid LQ is supplied, and the liquid LQ may be supplied from the supply flow path. In the first embodiment, the cleaning device 70 includes the acoustic lens 73, but may not include the acoustic lens 73. Even when the acoustic lens 73 is not provided, the ultrasonic waves can be focused at least in the arrangement direction of the channels CH. In the fourth embodiment, the cleaning device 70 does not include the acoustic lens 73, but may include the acoustic lens 73.

### F. Other Configurations

The present disclosure is not limited to the embodiments described above, and can be implemented in various forms without from the scope of the present disclosure. For example, the present disclosure may also be implemented in the following configurations. The technical features in the embodiments described above corresponding to the technical features in the configurations described below can be replaced or combined as appropriate in order to solve a part or all of the problems of the present disclosure, or to achieve a part of all of the effects of the present disclosure. Also, any of the technical features can be deleted as appropriate unless described as essential in the present specification.
(1) According to a first aspect of the present disclosure, there is provided a cleaning device for cleaning a nozzle plate having an ejection surface and a plurality of nozzles for ejecting liquid formed therein. The cleaning device includes a cap that is disposed to face the ejection surface, has a recess, and is configured to store the liquid in a space surrounded by the recess and the ejection surface, an ultrasonic device that is provided in the cap and transmits ultrasonic waves toward the ejection surface, and has a plurality of ultrasonic vibrators arranged in a first direction, and a controller that inputs a burst signal to the ultrasonic device and controls the ultrasonic device, wherein each ultrasonic vibrator of the plurality of ultrasonic vibrators transmits ultrasonic burst waves when the burst signal is input, and the controller acquires a deposition range in which deposits are deposited of a range including the ejection surface and the plurality of nozzles, sets a target range using the deposition range, and controls the ultrasonic device to focus the ultrasonic waves in the target range. According to the configuration, since the ultrasonic wave is focused not on the entire surface of the ejection surface but on a partial range, the deposits can be efficiently removed.
(2) In the aspect described above, the controller may control at least two ultrasonic vibrators among the plurality of ultrasonic vibrators to shift transmission timing of the burst waves from each other to focus the ultrasonic waves in the target range.
(3) In the aspect described above, the controller may control the ultrasonic vibrator to which the burst signal is input among the plurality of ultrasonic vibrators to shift the transmission time according to a distance between the target range and the ultrasonic vibrator. According to the configuration, ultrasonic waves having higher sound pressure can be transmitted to the target range.
(4) In the aspect described above, the controller may specify an abnormal nozzle which is a nozzle having an ejection abnormality among the plurality of nozzles, acquire a range including the specified abnormal nozzle as the deposition range, and set a range including at least one of the abnormal nozzle and a nozzle periphery which is a range on the ejection surface surrounding the abnormal nozzle as the target range. According to the configuration, the deposits that cause the ejection abnormality can be efficiently removed.
(5) In the aspect described above, the nozzle periphery may include a first nozzle periphery surrounding the abnormal nozzle and a second nozzle periphery surrounding the first nozzle periphery, and the controller may set a range not including the first nozzle periphery but including at least a part of the second nozzle periphery as the target range. According to the configuration, since the ultrasonic waves can be focused at a position deviated from the deposits deposited around the first nozzle, the deposits can be efficiently removed by generating a shear flow in the liquid.
(6) In the aspect described above, the controller may set a first range and a second range obtained by dividing the nozzle periphery, sets a first candidate range including at least a part of the first range, but not including the second range and a second candidate range including at least a part of the second range, but not including the first range as candidates for the target range, and set at least one of the first candidate range and the second candidate range as the target range. According to the configuration, by limiting the target range, it is possible to reduce the damage on the ejection surface by the ultrasonic waves.
(7) In the aspect described above, a first group of ultrasonic vibrators corresponding to the first candidate range and a second group of ultrasonic vibrators corresponding to the second candidate range may be determined in advance f for the plurality of ultrasonic vibrators, and the controller may control the first group of ultrasonic vibrators to cause the first group of ultrasonic vibrators to transmit the burst waves when setting the first candidate range as the target range, and control the second group of ultrasonic vibrators to cause the second group of ultrasonic vibrators to transmit the burst waves when setting the second candidate range as the target range.
(8) In the aspect described above, when the ejection abnormality of the abnormal nozzle is not eliminated after focusing the ultrasonic waves in the target range, the controller may focus the ultrasonic waves in the target range again. According to the configuration, the ultrasonic waves can be repeatedly transmitted to the target range until the ejection abnormality is eliminated.
(9) In the aspect described above, the controller may set a first range and a second range obtained by dividing the nozzle periphery, sets a first candidate range including at least a part of the first range, but not including the second range and a second candidate range including at least a part of the second range, but not including the first range as candidates for the target range, and when the ejection abnormality of the abnormal nozzle is not eliminated after setting the first candidate range as the target range and focusing the ultrasonic waves in the target range, set the second candidate range as the target range and focuses the ultrasonic waves in the target range. According to the configuration, since the number of times the ultrasonic waves are transmitted to the ejection surface can be reduced, damage on the ejection surface by the ultrasonic waves can be reduced.
(10) In the aspect described above, the ultrasonic device may include a plurality of ultrasonic vibrator arrays including the plurality of ultrasonic vibrators, and the plurality of ultrasonic vibrator arrays may be arranged in a second direction intersecting the first direction, but not intersecting the ejection surface at a right angle, and the controller may synchronize the transmission time of the ultrasonic vibrators arranged in the first direction and the transmission time of the ultrasonic vibrators arranged in the second direction with respect to the ultrasonic vibrators to which the burst signal is input among the plurality of ultrasonic vibrators to focus the ultrasonic n the target range.

According to the configuration, the ultrasonic waves can be focused at a desired position on the ejection surface.
(11) In the aspect described above, an acoustic lens disposed between the ultrasonic device and the ejection surface may be provided, wherein the acoustic lens may focus the ultrasonic waves transmitted from the ultrasonic vibrator in a lens focusing range on the ejection surface including the plurality of nozzles, the lens focusing range intersecting the first direction and having a predetermined length in a second direction parallel to the ejection surface. According to the configuration, the ultrasonic waves can be focused in the lens focusing range.

The present disclosure can be implemented in other various aspects than the cleaning device. For example, the present disclosure can be implemented in aspects of a cleaning method for a nozzle plate, a computer program for implementing the cleaning method, a non-transitory recording medium in which the computer program is recorded, or the like.

What is claimed is:

1. A cleaning device for cleaning a nozzle plate that has an ejection surface and a plurality of nozzles for ejecting a liquid formed therein, the cleaning device comprising:
a cap that is disposed to face the ejection surface, has a recess, and is configured to store the liquid in a space surrounded by the recess and the ejection surface;
an ultrasonic device that is provided in the cap and transmit ultrasonic waves toward the ejection surface, and has a plurality of ultrasonic vibrators arranged in a first direction; and
a controller that outputs a burst signal to the ultrasonic device and controls the ultrasonic device, wherein
each ultrasonic vibrator of the plurality of ultrasonic vibrators transmit ultrasonic burst waves when the burst signal is input, and
the controller acquires a deposition range in which deposits are deposited, sets a target range using the deposition range, and controls the ultrasonic device to focus the ultrasonic waves in the target range.

2. The cleaning device according to claim 1, wherein
the controller controls at least two ultrasonic vibrators among the plurality of ultrasonic vibrators to shift transmission timing of the burst waves from each other to focus the ultrasonic waves in the target range.

3. The cleaning device according to claim 2, wherein
the controller controls the ultrasonic vibrator to which the burst signal is input among the plurality of ultrasonic vibrators to shift the transmission time according to a distance between the target range and the ultrasonic vibrator.

4. The cleaning device according to claim 1, wherein
the controller specifies an abnormal nozzle which is a nozzle having an ejection abnormality among the plurality of nozzles, acquires a range including the specified abnormal nozzle as the deposition range, and sets a range including at least one of the abnormal nozzle and a nozzle periphery which is a range on the ejection surface surrounding the abnormal nozzle as the target range.

5. The cleaning device according to claim 4, wherein
the nozzle periphery includes a first nozzle periphery surrounding the abnormal nozzle and a second nozzle periphery surrounding the first nozzle periphery, and
the controller sets a range not including the first nozzle periphery but including at least a part of the second nozzle periphery as the target range.

6. The cleaning device according to claim 4, wherein
the controller sets a first range and a second range obtained by dividing the nozzle periphery, sets a first candidate range including at least a part of the first range, but not including the second range and a second candidate range including at least a part of the second range, but not including the first range as candidates for the target range, and sets at least one of the first candidate range and the second candidate range as the target range.

7. The cleaning device according to claim 6, wherein
the plurality of ultrasonic vibrators includes a first group of ultrasonic vibrators corresponding to the first candidate range and a second group of ultrasonic vibrators corresponding to the second candidate range, and
the controller controls the first group of ultrasonic vibrators to cause the first group of ultrasonic vibrators to transmit the burst waves when setting the first candidate range as the target range, and controls the second group of ultrasonic vibrators to cause the second group of ultrasonic vibrators to transmit the burst waves when setting the second candidate range as the target range.

8. The cleaning device according to claim 4, wherein
when the ejection abnormality of the abnormal nozzle is not eliminated after focusing the ultrasonic waves in the target range, the controller focuses the ultrasonic waves in the target range again.

9. The cleaning device according to claim 4, wherein
the controller sets a first range and a second range obtained by dividing the nozzle periphery, sets a first candidate range including at least a part of the first range, but not including the second range and a second candidate range including at least a part of the second range, but not including the first range as candidates for the target range, and when the ejection abnormality of the abnormal nozzle is not eliminated after setting the first candidate range as the target range and focusing the ultrasonic waves in the target range, sets the second candidate range as the target range and focuses the ultrasonic waves in the target range.

10. The cleaning device according to claim 2, wherein
the ultrasonic device includes a plurality of ultrasonic vibrator arrays including the plurality of ultrasonic vibrators, and the plurality of ultrasonic vibrator arrays are arranged in a second direction intersecting the first direction, but not intersecting the ejection surface at a right angle, and
the controller synchronizes the transmission time of the ultrasonic vibrators arranged in the first direction and the transmission time of the ultrasonic vibrators arranged in the second direction with respect to the ultrasonic vibrators to which the burst signal is input among the plurality of ultrasonic vibrators to focus the ultrasonic waves in the target range.

11. The cleaning device according to claim 1, further comprising an acoustic lens disposed between the ultrasonic device and the ejection surface, wherein
the acoustic lens focuses the ultrasonic waves transmitted from the ultrasonic vibrator in a lens focusing range on the ejection surface including the plurality of nozzles, the lens focusing range intersecting the first direction and having a predetermined length in a second direction parallel to the ejection surface.
